(19) United States
(12) Patent Application Publication
(10) Pub. No.: US 2015/0061425 A1
(43) Pub. Date: Mar. 5, 2015

(54) INTERNALLY COOLED SERVO MOTOR WITH SEGMENTED STATOR

(71) Applicant: Parker-Hannifin Corporation, Cleveland, OH (US)

(72) Inventors: Steven R. Huard, New Ulm, MN (US); Eric Hendrickson, New Ulm, MN (US); Jarred Drexler, New Ulm, MN (US); Jay Schultz, Rohnert Park, CA (US)

(21) Appl. No.: 14/397,731

(22) PCT Filed: Mar. 26, 2013
(86) PCT No.: PCT/US2013/033779

§ 371 Date: Oct. 29, 2014

Related U.S. Application Data
(60) Provisional application No. 61/640,659, filed on Apr. 30, 2012.

(51) Int. Cl. H02K 1/20; H02K 9/19; H02K 9/00

(52) U.S. Cl. CPC H02K 1/20; H02K 9/005; H02K 9/19
USPC 310/54; 310/59

(57) ABSTRACT

An electrical device and servo motor that includes a stator having a plurality of poles, wherein each pole includes a first surface and a second surface; the first surface and the second surface are spaced apart and have a pair of slots defined between the first surface and the second surface on respective sides of each pole. The pair of slots is configured to receive at least one winding, and each pole further includes a cooling tube coupled to the first surface, wherein the cooling tube is at least partially encompassed within the first surface.

### TECHNICAL FIELD

The present invention relates to active cooling of AC and DC electric motors, and more particularly, electric motors having a cooling tube formed in the back of the lamination segment and inside of the motor housing, which allows the use of water based or electrically conductive coolants to cool the stator coils.

### BACKGROUND OF INVENTION

There are three main classes of prior art for cooling an electric motor. The first class of liquid cooling involves using a liquid tight housing that is installed over the stator housing. The second class of liquid cooling involves flooding the inside of the motor housing with oil, or a suitable dielectric cooling fluid. The third class of liquid cooling involves using a two-phase liquid/gas coolant as depicted in U.S. Pat. No. 5,952,748.

There are a variety of disadvantages associated with these classes. Such disadvantages are disclosed in U.S. application Ser. No. 13/164,128, which is owned by the assignee of the subject application.

### SUMMARY

One aspect of the invention relates to a fluid cooled segmented servo motor lamination construction method that results in a very high power density. The high power density is achieved by incorporating a cooling tube into the back of the lamination segment and inside of the motor housing; a tapered pole body is used so that the magnetic flux density does not become elevated as it travels around the cooling tube; rectangular, square or ribbon wire may also be used to reduce thermal resistance and increase slot fill; round wire is also possible.

The output power of the servomotor can be increased by cooling the motor with a fluid. By placing the cooling tube in the back of the segmented lamination pole, the cooling path is shortened over external cooling. Also, the motor is smaller because an external fluid jacket is eliminated. By placing the cooling tube slot in the center of the lamination at the outer diameter and tapering the pole, the magnetic flux path can have minimum interruption, and the magnetic saturation is reduced. In one embodiment, the resistive losses in the motor are minimized by utilizing rectangular wire. By combining the cooling tube location, with the tapered pole, and the high slot fill, the power density of the motor is maximized.

### BRIEF DESCRIPTION OF THE DRAWINGS

Embodiments of this invention will now be described in further detail with reference to the accompanying drawings, in which:

FIG. 1 is a cross-section of an exemplary electric motor in accordance with aspects of the present invention.

FIGS. 2-4 are perspective views of an exemplary stator pole in accordance with aspects of the present invention.

FIGS. 5-6 are perspective views of an exemplary stator in accordance with aspects of the present invention.

FIG. 7 is an exploded view of a portion of the stator illustrated in FIG. 5.

### DETAILED DESCRIPTION OF THE DRAWING

An electric motor generates heat in the process of transforming electrical energy into mechanical energy. If this heat is not effectively dissipated to the surrounding environment the motor internal temperature will rise above the temperature rating of the individual components. Without an active cooling system such as a fan or liquid cooling system, the servo motor continuous output power can be extremely reduced from its full potential.

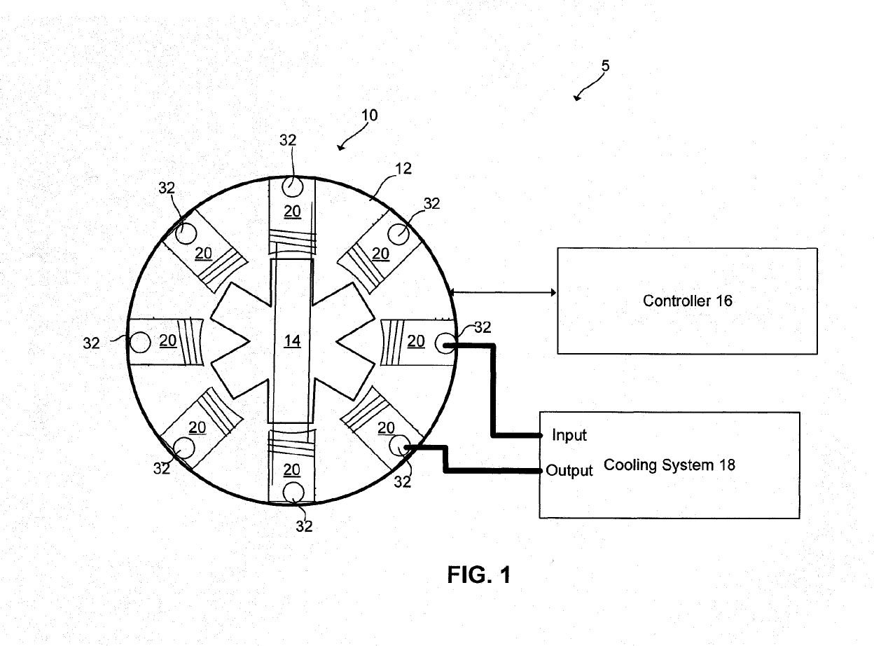

An exemplary motor control system 5 for a servo motor 10 is illustrated in FIG. 1. The servo motor 10 includes a stator 12 and a rotor 14. The stator 12 and the rotor 14 are configured are coaxially aligned such that the rotor and the stator 12 is selectively actuable to induce rotation of the rotor 14, as is conventional. A controller 16 may be used to control operation of the servo motor 10. A cooling system 18 may also be coupled to the stator through a fluid tube, as discussed below.

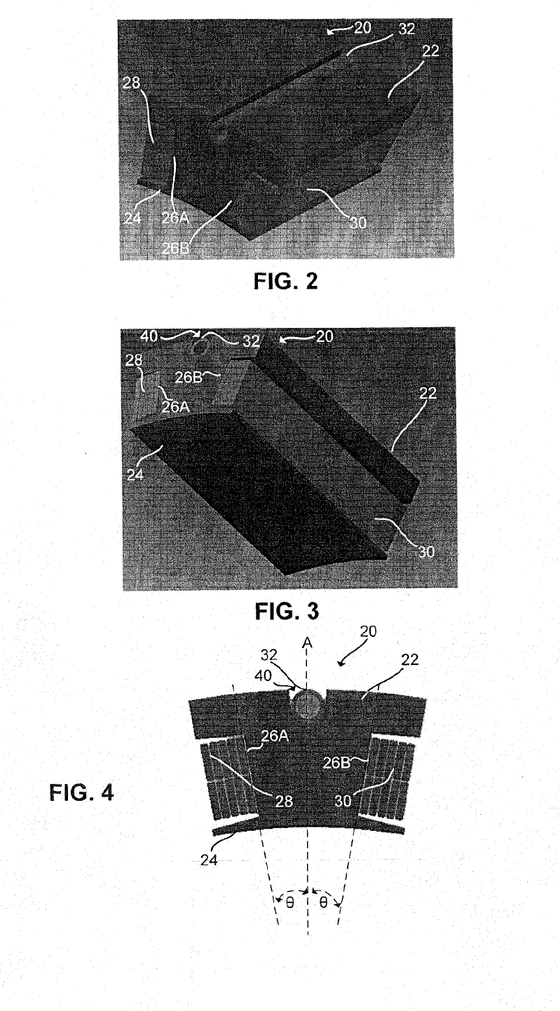

Referring to FIGS. 2-4, the stator 12 may be formed from a plurality of segmented laminates, which is conventional. The stator 12 includes a plurality of poles 20. Each of the poles 20 include a first surface 22 and a second surface 24. The first surface 22 and the second surface 24 are spaced apart (e.g., a distance (d)). Each of the poles 20 also have a pair of slots 26A, 26B defined between the first surface and the second surface on respective sides of each pole. Each pair of slots is configured to receive at least one winding 28, 30.

Each pole 20 further includes a cooling tube 32 coupled to the first surface 22, wherein the cooling tube is at least partially encompassed within the first surface 22. The first surface may include a recess 40, which may also be in the form of through hole or the like for coupling the cooling tube 32 to the pole 20. The cooling tube 32 is secured in a central portion of the first surface 22 along an axis of symmetry (A) of the pole. Preferably, the cooling tube 32 is embedded within the first surface or below the first surface 22 in such a manner that the cooling tube does not extend outward from the pole more than the first surface. In other embodiments, the cooling tube 32 may extend beyond surface 22. In still other embodiments, it may be desirable for separate cooling tubes 32 for forming more than one cooling tube (e.g., separate cooling tubes having parallel flow paths). In still other embodiments, or cooling tube 32 may be formed from a single continuous tube or tubes. Likewise, the cooling tube or tubes may be formed from a plurality of cooling tubes that are coupled together in an appropriate manner.

Each of the pairs of slots 26A, 26B are tapered a prescribed amount along an axis of symmetry of associated with each pole. For example, the slots 26A, 26B may be tapered between 5 and 30 degrees with respect to the axis of symmetry (A), as illustrated in FIG. 4. Preferably, each pair of slots 26A, 26B is tapered the same prescribed amount (θ). In another embodiment, the taper angles may be different.

The windings 28 and 30 may be any type of winding. In one embodiment, each winding has a rectangular cross-section, in order to increase slot fill and provide for low resistive losses. A tapered insulator cap may be used to force the rectangular wire to sit flat against the pole, thus reducing thermal impedance. In another embodiment, the windings 28 and 30 may have a circular cross-section. Windings can be manufactured without welds, solder or brazing, which increases reliability.

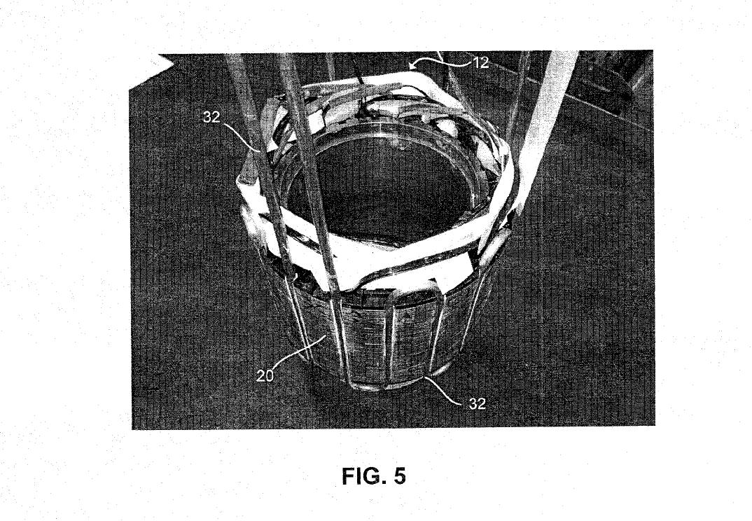

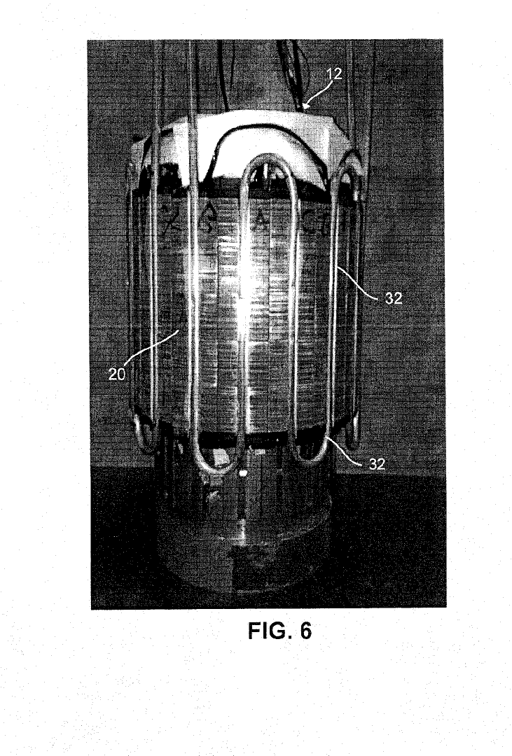

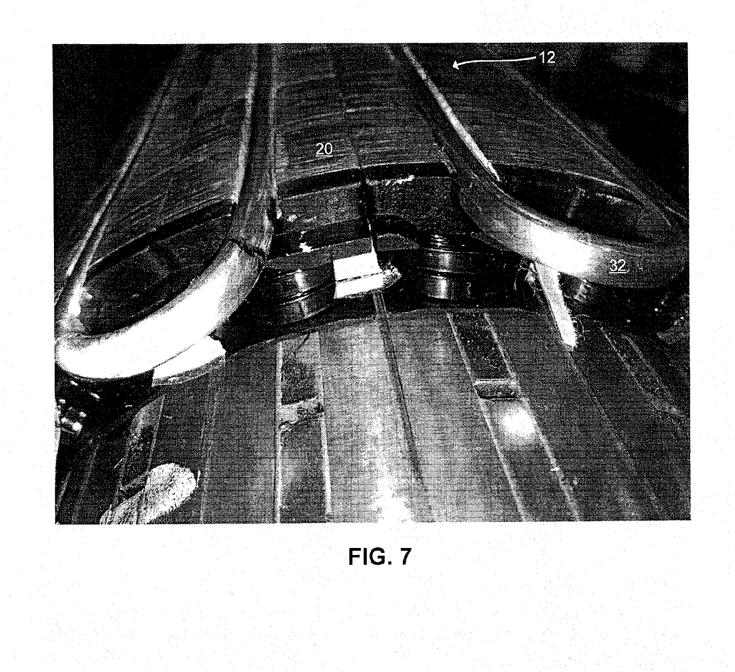

As shown in FIGS. 5-7, the cooling tube 32 is continuous and is routed to each of the poles. The cooling tube 32 includes an input end and an output end that is coupled to a cooling system (not shown). The cooling tube 32 may be made from any desirable material. Such materials include, for example, a copper alloy, an aluminum alloy, a stainless steel alloy, a polymide, etc. Since the stator 12 is cooled internally, an external water jacket that is common in certain systems is eliminated. This results in reduced size, weight and cost of the motor 10. A thermally conductive epoxy or paste can be applied between the cooling tube 32 and the pole 20 to further improve thermal transfer.

The cooling tube is suitable for transfer of fluid to provide cooling to the motor 10. Such fluids may include, water, a mixture of water glycol, R134, oil, a two-phase liquid gas mixture.

A servo motor 10 in accordance to this invention can be constructed with any desired number of stator teeth and magnet segments on the rotor. That is, the claimed invention is not limited to a particular number of stator teeth, magnet segments, or a particular cooling tube travel path. The servo motor depicted in FIGS. 1-7 is a permanent magnet synchronous servo motor. It is constructed with a rotor 14 that has permanent magnet segments attached circumferentially. The rotor 14 rotates on bearings, as is conventional. The stator 12 is constructed from electrical grade steel in the form of a stack of laminations in order to reduce eddy current and hysteresis losses. Coils of wire or windings 28, 30 are installed into the slots 26A, 26B between the laminations stacks (e.g., poles 20). A feedback device (not shown) is used to sense the rotor 14 position during motor operation.

During the operation of the servo motor, current is commanded through the motor windings 28, 30 that is a function of rotor position, and the commanded torque. Resistive losses in the motor windings 28, 30 and eddy currents and hysteresis losses in the lamination stack (e.g., poles 20) cause the motor to heat. The heat generated must be effectively removed from the motor or the motor will over heat.

The electric motor is equipped with a continuous cooling tube 32, as set forth above. Due to the coupling of the cooling tube 32 to the pole, as described above, there is a shorter heat flow path from the heat source to the heat sink over conventional methods. There is also a low thermal resistance path from the heat source to the heat sink.

In order to reduce the complexity of the assembly it is preferred that the tube has a minimum number of interconnection within the motor body. Therefore, a single pass continuous tube is preferred. It is possible to assemble the motor with a single continuous tube if the motor stator is built in segments. Likewise, it is preferable to locate the fluid tube 32 along the axis of symmetry (A) for each pole. Such location provides for optimization of magnetic flux flow, minimized magnetic lamination saturation, and minimum motor size. For in-slot cooling, it is possible to maximize the thermal path from the winding to the cooling tube by maximizing the thermal contact between the cooling tube and the wires and then encapsulate the entire stator in a thermally conductive epoxy. The encapsulation process also protects the insulation from abrasion failures.

The internal cooling loop can be used along with external cooling method to make even further improvement to the servo motor performance. The internal cooling loop will remove the heat from the resistive losses while the external cooling on the housing can remove the eddy current and hysteresis losses in the electrical steel, for example.

This invention is not limited to permanent magnet synchronous servo motors. It can also work on induction motors, PM brushed motors, Universal motors, and variable reluctance motors.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

1. An electrical device comprising:
a stator having a plurality of tapered pole bodies, wherein each tapered pole body includes a first surface and a second surface;
the first surface and the second surface are spaced apart and have a pair of slots defined between the first surface and the second surface on respective sides of each tapered pole body,
wherein the pair of slots is configured to receive at least one winding, and each tapered pole body further includes a cooling tube coupled to the first surface, wherein the cooling tube is at least partially encompassed within the first surface, and
wherein the tapered pole bodies are configured to prevent elevation of magnetic flux density traveling around the cooling tube.

2. The electrical device of claim 1, wherein the cooling tube is secured in a central portion of the first surface along an axis of symmetry of the tapered pole body.

3. The electrical device of claim 1, wherein the cooling tube is embedded within the first surface in such a manner that the cooling tube does not extend outward from the tapered pole body more than the first surface.

4. The electrical device of claim 1, wherein the stator is formed from a plurality of segmented laminates.

5. The electrical device of claim 1, wherein the each of the pairs of slots are tapered a prescribed amount along an axis of symmetry of associated with each tapered pole body.

6. The electrical device of claim 1, wherein each winding has one of a rectangular cross-section or a circular cross-section.

7. (canceled)

8. The electrical device of claim 1, wherein the cooling tube is at least one of a continuous tube or formed from a plurality of cooling tubes.

9. (canceled)

10. (canceled)

11. The electrical device of claim 1, wherein the cooling tubes from a plurality of parallel flow paths in each tapered pole body.

12. The electrical device of claim 1, wherein the cooling tube is made from one of a copper alloy, an aluminum alloy, a stainless steel alloy, or polymide.

13. (canceled)

14. (canceled)

15. (canceled)

16. The electrical device of claim 1, further including a rotor having at least two magnet poles that is installed within the stator and the magnet poles presented circumferentially on the said rotor.

17. The electrical device of claim 1, wherein the cooling tube is suitable for transfer at least one of a group of fluids consisting of: water, a mixture of water glycol, R134, oil, a two-phase liquid gas mixture.

18. A servo motor comprising:
a stator having a plurality of tapered pole bodies, wherein each tapered pole body includes a first surface and a second surface;
the first surface and the second surface are spaced apart and have a pair of slots defined between the first surface and the second surface on respective sides of each tapered pole body,
wherein the pair of slots is configured to receive at least one winding, and each tapered pole body further includes a cooling tube coupled to the first surface, wherein the cooling tube is at least partially encompassed within the first surface, and
wherein the tapered pole bodies are configured to prevent elevation of magnetic flux density traveling around the cooling tube; and
a rotor that is installed coaxially within the said stator, wherein the rotor includes at least two slots on the rotor and at least two conductive bars on the rotor that extend circumferentially on the rotor.

19. The servo motor of claim 18, wherein the cooling tube is secured in a central portion of the first surface along an axis of symmetry of the tapered pole body.

20. The servo motor of claim 18, wherein the cooling tube is embedded within the first surface in such a manner that the cooling tube does not extend outward from the tapered pole body more than the first surface.

21. The servo motor of claim 18, wherein the stator is formed from a plurality of segmented laminates.

22. The servo motor of claim 18, wherein the each of the pairs of slots are tapered a prescribed amount along an axis of symmetry of associated with each tapered pole body.

23. The servo motor of claim 18, wherein each winding has one of a rectangular cross-section or a circular cross-section.

24. (canceled)

25. The servo motor of claim 18, wherein the cooling tube is at least one of a continuous tube or formed from a plurality of cooling tubes.

26. (canceled)

27. (canceled)

28. (canceled)

29. The servo motor of claim 25, wherein the cooling tubes from a plurality of parallel flow paths in each tapered pole body.

30. The servo motor of claim 18, wherein the cooling tube is made from a copper alloy, an aluminum alloy, a stainless steel alloy, or polymide.

31. (canceled)

32. (canceled)

33. (canceled)

34. The servo motor of claim 18, wherein the cooling tube is suitable for transfer at least one of a group of fluids consisting of: water, a mixture of water glycol, R134, oil, a two-phase liquid gas mixture.
